(19) United States
(12) Patent Application Publication
(10) Pub. No.: US 2020/0244086 A1
(43) Pub. Date: Jul. 30, 2020

(54) RECEPTACLE WITH POWER CHARGING DEVICE

(71) Applicant: Oxti Corporation, Taipei (TW)

(72) Inventor: Chih Feng HO, Taipei (TW)

(21) Appl. No.: 16/257,121

(22) Filed: Jan. 25, 2019

(51) Int. Cl. H02J 7/00; A45C 15/00; H01M 2/10

(52) U.S. Cl. CPC H02J 7/0045; H02J 7/0054; H02J 2007/0059; H01M 2/1022; A45C 15/00

(57) ABSTRACT

A receptacle assembly includes a chamber formed in a housing, a cover pivotally connected to the housing with a hinge device, a mobile power member disposed in the housing and detachably attached to the housing, an electric power device includes a battery disposed in the housing and connected to the mobile power member, a charging connecting interface is connected to the battery, and an electric power output is connected to the battery. A vehicle charging terminal is connected to the battery. An AC/DC converter is connected to the battery, and an indoor charging terminal is connected to the AC/DC converter. A DC/AC converter is connected to the battery and the electric power output.

### BACKGROUND OF THE INVENTION

### 1. Field of the Invention

The present invention relates to a portable receptacle, and more particularly to a portable receptacle with an electric power charging device or combination including an improved and simplified structure or configuration for allowing the receptacle to be easily carried and moved outdoors and for suitably and easily and quickly and readily charging various electric devices or facilities that consume or that require either alternative current (AC) or direct current (DC) electric power.

### 2. Description of the Prior Art

Typical electric devices or facilities, such as videos, audios, electric fans, micro ovens, induction cookers, electric ovens, light devices, may be used while camping or conducting various outdoor activities, and normally, the electric devices or facilities are electrically connected or coupled to the vehicle electric power suppliers with a wire or cable, but the vehicle should be started and idled to charge the battery and to supply the electric power to energize the electric devices or facilities.

Alternatively, a wire or cable may directly and electrically connect or couple the electric devices or facilities to the indoor electric power suppliers of the house families. But, it will be difficult to electrically connect or couple the electric devices or facilities to the indoor electric power suppliers of the house families while camping or conducting various outdoor activities.

For suitably charging various electric devices or facilities, various portable electric power charging devices or assemblies have been developed and provided for charging the electric devices or facilities outdoors, and normally comprise a number of parts and elements received in a suitcase or luggage or receptacle for allowing the electric power charging devices or assemblies to be easily carried and moved outdoors.

For example, U.S. Pat. No. 4,389,469 to Nicholls, U.S. Pat. No. 6,042,426 to Byrne, U.S. Pat. No. 9,219,341 B1 to O'Keefe et al., and U.S. Pat. No. 9,543,770 to O'Keefe et al. disclose several of the typical electric power charging devices or assemblies each also comprise a number of parts and elements for charging the electric devices or facilities.

However, the typical electric power charging devices or assemblies may only be used for charging limited electric devices or facilities, but may not be used for charging the electric devices or facilities that consume or that require either alternative current (AC) or direct current (DC) electric power. In addition, the typical electric power charging devices or assemblies may be easily carried and moved outdoors for charging various electric devices or facilities.

The present invention has arisen to mitigate and/or obviate the afore-described disadvantages of the conventional electric power charging devices or facilities.

### SUMMARY OF THE INVENTION

The primary objective of the present invention is to provide a portable receptacle including an improved and simplified structure or configuration for allowing the receptacle to be easily carried and moved outdoors and for suitably and easily and quickly and readily charging various electric devices or facilities that consume or that require either alternative current (AC) or direct current (DC) electric power.

In accordance with one aspect of the invention, there is provided a portable receptacle with an electric power charging combination comprising a receptacle body including a housing having a chamber formed in the housing, and a cover pivotally connected to the housing with a hinge device for allowing the housing and the cover to be opened relative to each other, a mobile power member disposed in the chamber of the housing and detachably attached to the housing, an electric power device including a battery disposed in the chamber of the housing and electrically connected to the mobile power member, a charging connecting interface electrically connected to the battery, and an electric power output electrically connected to the battery, and arranged for allowing the receptacle to be easily carried and moved outdoors and for suitably and easily and quickly and readily charging various electric devices or facilities that consume or that require either alternative current (AC) or direct current (DC) electric power. It is to be noted that the receptacle with the electric power device may be easily carried and moved outdoors and/or to any selected places or positions.

The electric power device includes a step down rectification device connected to the battery and connected to the mobile power member. The charging connecting interface includes a vehicle charging terminal electrically connected to the battery for connecting to various electric devices or facilities with wires or cables.

The electric power device includes an AC/DC converter electrically connected to the battery, and the charging connecting interface includes an indoor charging terminal connected to the AC/DC converter for suitably charging the battery. The electric power device includes a DC/AC converter electrically connected to the battery, and the DC/AC converter is electrically connected to the electric power output for suitably supplying the electric energy to charge various electric devices or facilities.

The housing includes at least one lock member, and the cover includes at least one lock element for engaging with the lock member of the housing and for selectively locking the housing and the cover together and for preventing the parts or elements or other electric devices or facilities from being disengaged from the housing of the portable receptacle.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a portable receptacle assembly with an electric power charging combination, in a close position or structure or configuration, illustrating the operation of the electric power charging combination;

FIG. 2 is another perspective view of the portable receptacle assembly with the electric power charging combination, in an opened position or structure or configuration;

FIG. 3 is a partial exploded view illustrating the operation of the electric power charging combination of the portable receptacle assembly;

FIG. 4 is a further perspective view of the portable receptacle assembly with the electric power charging combination, in a close position or structure or configuration, illustrating the operation of the electric power charging combination; and

FIG. 5 is a block diagram illustrating the parts and elements of the electric power charging combination.

### DETAILED DESCRIPTION OF THE PREFERRED EMBODIMENT

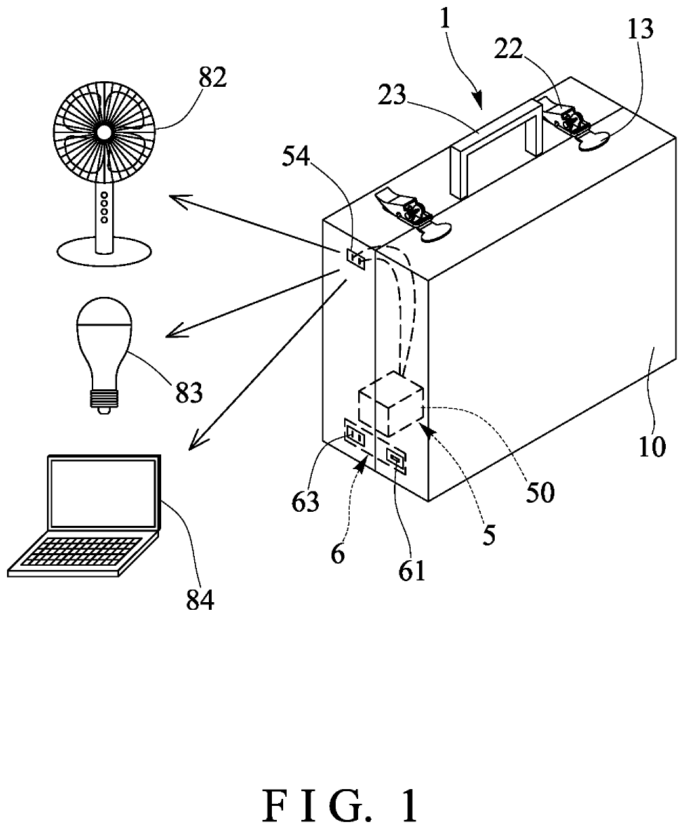

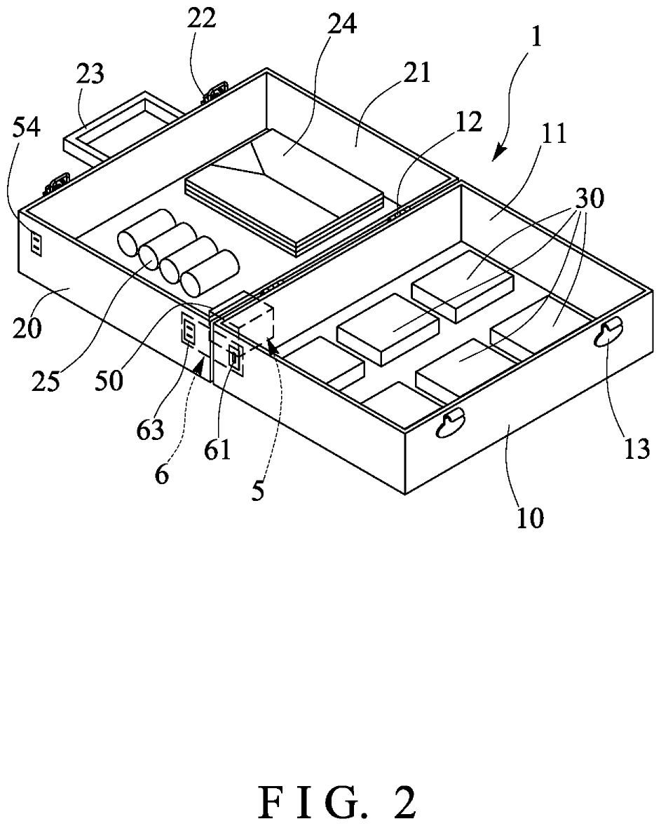

Referring to the drawings, and initially to FIGS. 1-4, a portable receptacle assembly with an electric power charging device or combination in accordance with the present invention may be arranged or selected from a container or suitcase or luggage and comprises a receptacle 1 including a base or housing 10 having a compartment or chamber 11 formed therein, and a casing or cover 20 having a chamber or compartment 21 formed therein, the housing 10 and the cover 20 may be selectively and pivotally or rotatably connected or coupled together with a pivot member or hinge device 12 to form a foldable or openable structure or configuration and for allowing the housing 10 and the cover 20 to be closed or opened relative to each other. The chamber 11 of the housing 10 and/or the compartment 21 of the cover 20 may be provided for receiving or engaging with various elements or objects 24, such as cloths 24, food 25 or the like (FIG. 2).

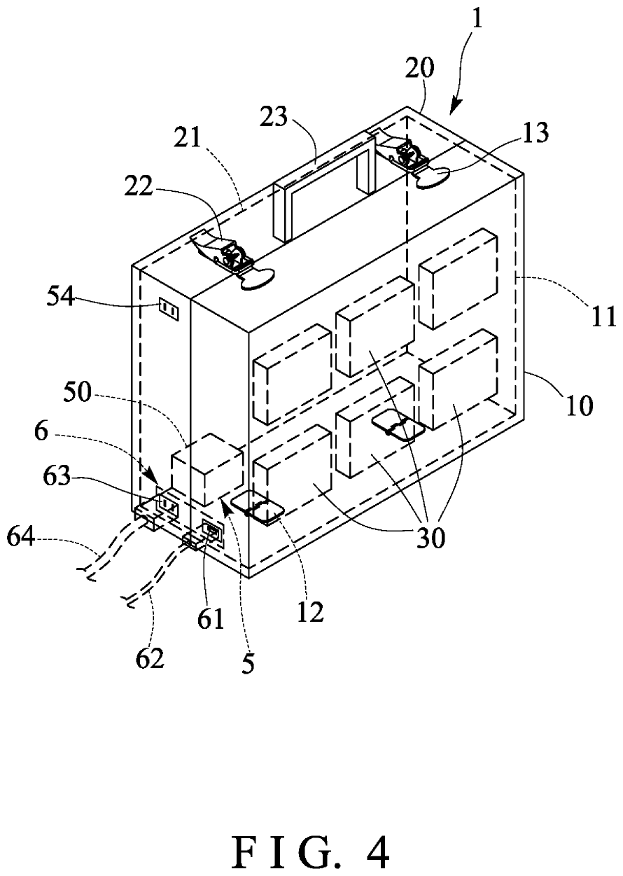

The housing 10 may include one or more (such as two) hooks or catches or lock members 13 formed or provided thereon, and the cover 20 may include one or more (such as two) buckles or latches or lock elements 22 for selectively engaging with the lock members 13 of the housing 10 and for selectively latching or locking the housing 10 and the cover 20 together (FIGS. 1, 4). The housing 10 and/or the cover 20 of the receptacle 1 may include a hand grip or handle 23 formed or provided on either the housing 10 or the cover 20 for allowing the housing 10 of the receptacle 1 to be easily transported and carried with the user and to be easily moved outdoors and for suitably and easily and quickly and readily charging various electric devices or facilities that consume or that require either alternative current (AC) or direct current (DC) electric power.

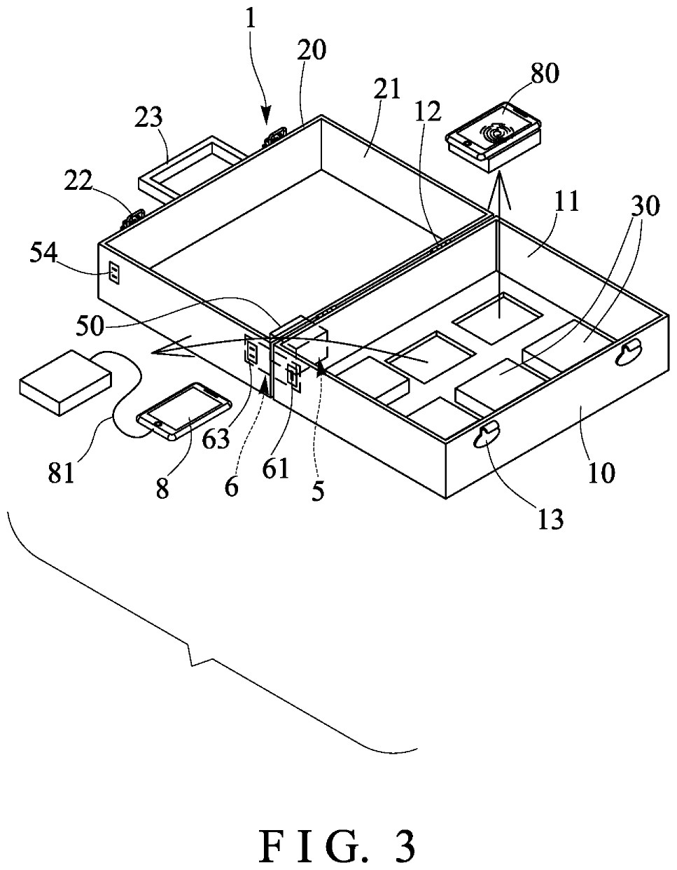

For example, one or more mobile power devices or members 30 (FIGS. 2-4) are disposed or engaged into the chamber 11 of the housing 10, and detachably or removably attached or mounted or secured to the housing 10 with fasteners (not illustrated) or the like, such as adhesive materials, hook and loop fastening elements (not illustrated) or the like for allowing the mobile power members 30 to be selectively detached or removed or disengaged from the housing 10 (FIG. 3), and for selectively charging the electric devices or facilities, such as the mobile or portable phones 8, 80 with a wire or cable 81 or wirelessly.

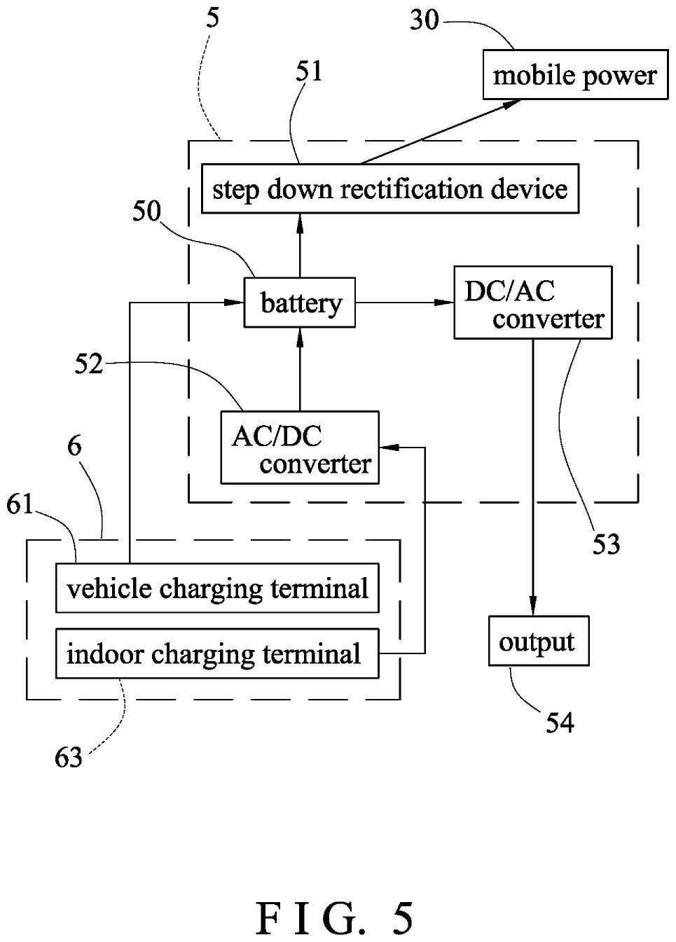

As shown in FIG. 5, the electric power charging combination in accordance with the present invention further includes an electric power module or device 5 having a battery 50 disposed or engaged into the chamber 11 of the housing 10, a buck or step down rectification module or device 51 connected or coupled to the battery 50, and also connected or coupled to the mobile power member 30 for supplying the electric power of the battery 50 to energize or to charge the mobile power member 30 with the direct current (DC) electric power, in which the mobile power member 30 may be used for selectively charging the electric devices or facilities 8, 80 with a wire or cable 81 or wirelessly (FIG. 3). The battery 50 may also be directly connected or coupled to the mobile power member 30 without the buck or step down rectification device 51.

The electric power charging combination in accordance with the present invention further includes a socket device or charging connecting interface 6 attached or mounted or secured to the receptacle 1, for example, the charging connecting interface 6 includes a vehicle charging terminal 61 disposed or attached to the cover 20 or the housing 10 for electrically connecting or coupling to vehicle electric power supply (not illustrated) with a wire or cable 62 (FIG. 4), and the vehicle charging terminal 61 is electrically connected or coupled to the battery 50 for allowing the battery 50 to be suitably and selectively charged with the vehicle electric power supply when required.

The charging connecting interface 6 further includes an indoor charging terminal 63 disposed or attached to the housing 10 or the cover 20 for electrically connecting or coupling to the indoor electric power supply (not illustrated) with a wire or cable 64 (FIG. 4), and the indoor charging terminal 63 is electrically connected or coupled to the battery 50 with or through an AC/DC converter 52 for allowing the battery 50 to be suitably and selectively charged with the alternative current (AC) electric power of the indoor electric power suppliers of the house families.

The electric power module or device 5 further includes a DC/AC converter 53 electrically connected or coupled to the battery 50 for receiving the electric power from the battery 50, and the DC/AC converter 53 is electrically connected or coupled to an electric power output 54 which is disposed or attached to the housing 10 or the cover 20 for electrically connecting or coupling to various electric devices or facilities 82-84, such as videos, audios, electric fans 82, micro ovens, induction cookers, electric ovens, light devices 83, computers or notebooks 84 or the like, best shown in FIG. 1. The battery 50 may also be directly connected or coupled to the electric power output 54 without the DC/AC converter 53.

In operation, as shown in FIGS. 1-2 and 4, the mobile power members 30 and the electric power device 5 and/or the elements or objects 24, 25 may be received or engaged in the cover 20 or the housing 10 of the receptacle 1 and may be suitably and selectively and easily carried and moved outdoors. As shown in FIG. 3, the mobile power members 30 may be selectively detached and removed or disengaged from the housing 10 for selectively charging the electric devices or facilities, such as the mobile or portable phones 8, 80 with a wire or cable 81 or wirelessly. As shown in FIG. 1, the battery 50 may be used for selectively charging the electric devices or facilities 82-84, such as videos, audios, electric fans 82, micro ovens, induction cookers, electric ovens, light devices 83, computers or notebooks 84 or the like.

Accordingly, the portable receptacle with the electric power charging combination in accordance with the present invention includes an improved and simplified structure or configuration for allowing the receptacle to be easily carried and moved outdoors and for suitably and easily and quickly and readily charging various electric devices or facilities that consume or that require either alternative current (AC) or direct current (DC) electric power.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A receptacle assembly comprising:
a receptacle including a housing having a chamber formed in said housing, and a cover pivotally connected to said housing with a hinge device for allowing said housing and said cover to be opened relative to each other,
a mobile power member disposed in said chamber of said housing and detachably attached to said housing,
an electric power device including a battery disposed in said chamber of said housing and electrically connected to said mobile power member,
a charging connecting interface electrically connected to said battery, and
an electric power output electrically connected to said battery.

2. The receptacle assembly as claimed in claim 1, wherein said electric power device includes a step down rectification device connected to said battery and connected to said mobile power member.

3. The receptacle assembly as claimed in claim 1, wherein said charging connecting interface includes a vehicle charging terminal electrically connected to said battery.

4. The receptacle assembly as claimed in claim 1, wherein said electric power device includes an AC/DC converter electrically connected to said battery, and said charging connecting interface includes an indoor charging terminal connected to said AC/DC converter.

5. The receptacle assembly as claimed in claim 1, wherein said electric power device includes a DC/AC converter electrically connected to said battery, and said DC/AC converter is electrically connected to said electric power output.

6. The receptacle assembly as claimed in claim 1, wherein said housing includes at least one lock member, and said cover includes at least one lock element for engaging with said at least one lock member of said housing and for selectively locking said housing and said cover together.
